(19) United States
(12) Patent Application Publication
(10) Pub. No.: US 2021/0140626 A1
(43) Pub. Date: May 13, 2021

(54) Telescopic Lighted Hook

(71) Applicants: Donald Bolduc, Buckland (CA); Rene Ouellet, St-Anselme (CA)

(72) Inventors: Donald Bolduc, Buckland (CA); Rene Ouellet, St-Anselme (CA)

(21) Appl. No.: 16/680,829

(22) Filed: Nov. 12, 2019

(51) Int. Cl. F21V 33/00; B62D 33/02; F21V 21/22; F21L 4/00

(52) U.S. Cl. CPC F21V 33/0084; F21L 4/00; F21V 21/22; B62D 33/02

(57) ABSTRACT

A truck box and a hook member for mounting in the truck box for use in pulling articles in the truck box toward the user includes a hook member having a telescopic pole, a hook at an outer end of the telescopic pole having a base portion attached to the telescopic pole, a hook portion extending at right angles outwardly to one side of the telescopic pole, a battery powered light mounted at the base portion and arranged to direct a beam along the hook portion in order to light the object to grab and at least two brackets attached to a pick-up box at said one side wall to hold the hook member when not used.

The invention relates to a telescopic pole with a hook at the end and a battery powered light at the hook end of the pole. This hook is used to grab material in the box of a pick-up truck or any other vehicle without having to climb in the vehicle. Brackets mount the hook on one side wall of the truck box.

### SUMMARY OF THE INVENTION

According to the invention there is provided a hook member for mounting in a truck box for use in pulling articles in the truck box toward the user, the hook member comprising:

a telescopic pole;

a hook at an outer end of the telescopic pole comprising:
a base portion attached to the telescopic pole;
a hook portion extending outwardly to one side of the telescopic pole;
a battery powered light mounted at the base portion and arranged to direct a beam along the hook portion in order to light the object to grab.

In one embodiment the hook portion has an under surface which has a plurality of serrated teeth along its length.

In one embodiment the hook portion has a down-turned nose at an end thereof spaced from the pole.

In one embodiment the hook is integrally molded from a plastics material such as a fiberglass reinforced plastic but it could be made of any other reinforced plastic or aluminum.

In one embodiment the hook portion is elongate with an upper surface and an under surface both generally at right angles to the pole.

In one embodiment the upper and under surfaces have an aperture therebetween bridged by a plurality of bridge members.

In one embodiment the base portion has a cylindrical receptacle molded therein into which the battery powered light is inserted.

In one embodiment there are provided at least two brackets arranged to be attached to a pick-up box at one side wall to hold the hook member when not used where the brackets are shaped for attachment to a top rail of the truck box. Preferably the brackets are shaped relative to the pole such that the pole is inserted press-fit in the bracket so that the pole is held fixed when the pick-up truck is vibrating or moving.

### BRIEF DESCRIPTION OF THE DRAWINGS

One embodiment of the invention will now be described in conjunction with the accompanying drawings in which:

FIG. 1 is side elevational view of the hook according to the present invention.

FIG. 2 is a side elevational view of the hook portion only of FIG. 1.

FIG. 3 is an isometric view of a truck box with the hook mounted therein on brackets.

FIG. 4 is a cross-sectional view along the side wall.

In the drawings like characters of reference indicate corresponding parts in the different figures.

### DETAILED DESCRIPTION

FIG. 1 shows the telescopic pole 1 with the hook 2 and a battery powered light 3. The telescopic pole includes two or more tubes one slidable in the next and is extended by pushing on a button 7 which allows sliding movement and releasing the button when the desired length is reached.

FIG. 2 shows a detailed view of the hook portion 2 which extends generally at right angles to the pole 1 and includes a base portion 21 with a sleeve 22 receiving the pole. From the base portion extends a bar 23 with a smooth outer curved surface 24 and an inner surface 25 with a series of serrated teeth 5. There is a cavity 9 in the base portion 21 of the hook 2 where the battery powered light is inserted. The cavity is on the inside of the base portion 21 so as to provide a beam of light along the inner surface 25 of the hook. The hook ends with a nose or tip 6 which is turned back at inclined surface 61 to help the hook hold on to materials to be moved or pulled toward the user. The hook also has many teeth 5 to further help it holding the material to move.

FIG. 3 shows a pick-up box 10 with the telescopic lighted hook 1 and two brackets 4 to hold the telescopic lighted hook inside one side wall of the pick-up truck box when the telescopic lighted hook is not used. FIG. 4 shows a cut view of the pick-up truck box 10 with the bracket 4 that is attached to the pick-up truck box with a set screw 8 inserted into the bracket and tightened against the top rail 81 of the box. The telescopic lighted hook 1 is inserted in the brackets 4 so as to lie along the side wall. The bracket 4 is designed in such a way that the pole 1 is press-fitted in the bracket when it is inserted such that the pole 1 cannot move when the pick-up truck is on the road.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. A hook member for mounting in a truck box for use by a user in pulling an article in the truck box toward the user, the hook member comprising:
a telescopic pole;
a hook at an outer end of the telescopic pole comprising:
a base portion attached to the telescopic pole;
an elongate hook portion extending outwardly to one side of the telescopic pole, the elongate hook portion including an outer face on a side thereof opposite to the telescopic pole and an inner face on a side thereof adjacent the telescopic pole;
a battery powered light mounted at the base portion and arranged to direct a beam outwardly to said one side of the telescopic pole along the inner face of the hook portion in order to light the article to be pulled.

2. The hook member according to claim 1 wherein the inner face of the hook portion has a plurality of transversely extending serrated teeth at longitudinally spaced positions along its length.

3. The hook member according to claim 1 wherein the inner face of the hook portion has a down-turned nose at an end thereof spaced from the pole.

4. The hook member according to claim 1 wherein the hook is integrally molded from a plastics material.

5. (canceled)

6. The hook member according to claim 1 wherein the outer face and inner face have an aperture therebetween bridged by a plurality of bridge members.

7. The hook member according to claim 1 wherein the base portion has a cylindrical receptacle molded therein into which the battery powered light is inserted.

8. The hook member according to claim 1 including at least two brackets arranged to be attached to the pick-up box at one side wall to hold the hook member when not used.

9. The hook member according to claim 1 wherein the brackets are shaped for attachment to a top rail of the truck box.

10. The hook member according to claim 1 wherein the brackets are shaped relative to the pole such that the pole is inserted as a press-fit in the brackets so that the pole is held fixed when the truck box is vibrating or moving.

11. A combination of a truck box having a side wall and a hook member for mounting to the truck box for use in pulling an article in the truck box toward a user according to claim 1

12-18. (canceled)
